(19) United States
(12) Patent Application Publication
(10) Pub. No.: US 2025/0354591 A1
(43) Pub. Date: Nov. 20, 2025

(54) METHOD FOR ASCERTAINING A MOTOR CONSTANT, A FAULT STATE AND/OR WEAR STATE, AS WELL AS A CONTACT POINT, CONTROL UNIT, FRICTION BRAKE

(71) Applicant: Robert Bosch GmbH, Stuttgart (DE)

(72) Inventors: Daniel Stuemke, Murrhardt (DE); Jan Lauble, Simmozheim (DE); Simon Peter, Weil Der Stadt (DE)

(21) Appl. No.: 19/186,768

(22) Filed: Apr. 23, 2025

(30) Foreign Application Priority Data
May 17, 2024 (DE) 10 2024 204 569.1

(51) Int. Cl. F16D 65/22; F16D 66/00; F16D 66/02; F16D 121/24

(52) U.S. Cl. CPC F16D 65/22; F16D 66/023; F16D 2066/003; F16D 2121/24

(57) ABSTRACT

A method for ascertaining a motor constant of an electric machine, in particular an actuator assembly. At least one excitation signal having at least one direct current component and one alternating current component is specified. The machine is controlled using the excitation signal. At least one actual value of a motor current of the machine and one actual value of a rotation rate of a rotor shaft of the machine are ascertained in each case. The motor constant is ascertained as a function of the excitation signal and the actual values.

### CROSS REFERENCE

The present application claims the benefit under 35 U.S.C. § 119 of German Patent Application No. DE 10 2024 204 569.1 filed on May 17, 2024, which is expressly incorporated herein by reference in its entirety.

### FIELD

The present invention relates to a method for ascertaining a motor constant of an electric machine, and to a method for ascertaining a fault state and/or wear state of a friction brake and to a method for ascertaining a contact point of two friction partners of a friction brake, in each case as a function of a motor constant ascertained in this way.

In addition, the present invention relates to a control unit specifically configured for performing at least one of the methods mentioned, and to a friction brake with such a control unit.

### BACKGROUND INFORMATION

Certain hydraulically actuated friction brakes for motor vehicles are described in the related art. Such hydraulic brakes typically use a pressure sensor in a hydraulic system in order to ascertain a clamping force of the corresponding brakes, which can inter alia be used to estimate and control a braking torque. Uncertainties in the friction pairing (variation of the friction value and thus of the brake characteristic value) represent a decisive limitation on the accuracy of the braking torque estimate.

Changed boundary conditions, for example in electric vehicles, may also make the use of electromechanically actuated brakes (EMB) attractive. Here, the question arises as to a suitable sensor system at the actuator level, analogous to the pressure sensor mentioned. The expense for a sensor system for direct measurement of operating parameters and of an actuation force is greatly increased in comparison to hydraulic brakes, in particular since measurements must be carried out in each wheel actuator and harsh environmental conditions (heat, dust, moisture, vibration, etc.) prevail.

### SUMMARY

In a method according to an example embodiment of the present invention, the present invention for ascertaining a motor constant of an electric machine, at least one excitation signal having at least one direct current component and one alternating current component is specified, in that the machine is controlled by means of the excitation signal, in that at least one actual value of a motor current of the machine and one actual value of a rotation rate of a rotor shaft of the machine are ascertained in each case, and in that the motor constant is ascertained as a function of the excitation signal and the actual values. Determining system parameters once, such as the motor constant or viscosity friction coefficients, is helpful only to a limited extent due to manufacturing tolerances and degradation effects over the component service life. The present invention is therefore based on the idea of providing a method by which at least the motor constant is determinable in a simple manner as an important system parameter as needed, in particular regularly. This advantageously ensures that corresponding component accuracies and wear within the system that affect the motor constant are taken into account. In this respect, the core of the invention lies in providing the specific excitation signal by means of which a motor current to be adjusted is defined as a desired current profile and by means of which the machine is controlled. According to an example embodiment of the present invention, the excitation signal has at least one, in particular constant, direct current component and one, in particular sinusoidal, alternating current component. The corresponding direct current component advantageously ensures that the excitation signal does not have a zero crossing and that the direction of rotation of the machine thus does not change. From the corresponding system response of the system, characterized at least by the actual values of the motor current and rotation rate that are ascertained according to the present invention, the motor constant and in particular further parameters, such as friction coefficients, are ascertained in a simple manner using signal processing methods. Here, a rotation rate is understood to mean a rotational speed or angular velocity of a rotor shaft of the machine. The electric machine is in particular part of an actuator assembly, for example a friction brake of a motor vehicle. The actuator assembly is in particular designed to displace a corresponding friction partner of the friction brake, for example by means of a gear assembly. The friction brake is in particular designed as an electromechanical drum brake, drum brake, or disk brake. The friction partner, which can be displaced by the actuator assembly, is in particular a brake pad, which is arranged on a brake shoe or brake caliper, for example, and is displaced to a brake drum or brake disk that also comprises a brake pad, in order to generate a braking torque. For reliable operation of the machine as part of a corresponding actuator assembly, such as a friction brake, it is therefore imperative to re-ascertain correspondingly uncertain and/or unknown values of relevant system parameters regularly. The method according to the invention provides a particularly advantageously efficient and robust procedure for repeatedly determining the motor constant as an important system parameter. Preferably, at least one further system parameter, in particular a Coulomb or viscous friction coefficient of the system, is determined as a function of a motor constant ascertained in this way. In this respect, the method according to the invention creates advantageous multi-parameter identification for the system. Based on the parameters ascertained by the method according to the invention, functionalities such as fault, damage, and wear detection can advantageously be implemented, or control loops can be recalibrated. The method is in particular performed as a regular self-check routine. The method also has the advantage that no additional sensors are required; instead, in particular, an already present motor position sensor (rotor position sensor) is used to ascertain the actual values of the rotation rate and an already present piece of information/current sensor system is used to ascertain the actual values of the motor current. Costs and technical complexity of the actuator assembly are thus not further increased. Of course, the method is not limited to the described application of the friction brake but can be used in any actuator assembly with electric machines.

According to a preferred development of the present invention, it is provided that actual temporal profiles of the motor current and of the rotation rate that result from the excitation signal are ascertained in each case, and that average values are ascertained as respective actual values as a function of the actual profiles. Taking into account average values creates a particularly advantageously simple way of ascertaining the actual values.

Particularly preferably, according to an example embodiment of the present invention, it is provided that the actual profiles are ascertained over at least two periods of the alternating current component. Ascertaining over a plurality of periods advantageously further increases the robustness of the method according to the present invention.

According to a preferred development of the present invention, it is provided that the alternating current component has at least one harmonic frequency, in particular a plurality of different harmonic frequencies. Using harmonic frequencies advantageously further improves the robustness and accuracy in ascertaining the motor constant.

Particularly preferably, according to an example embodiment of the present invention, it is provided that an average value of the motor constant is ascertained by means of a plurality of different excitation signals. Taking into account a plurality of excitation signals results in the advantage that the number of measurement data is increased and the robustness of the method according to the invention is thus further improved.

According to a preferred development of the present invention, it is provided that the motor constant is ascertained by means of a Fourier transform. Using a Fourier transform advantageously ensures that the motor constant is ascertained particularly efficiently.

Particularly preferably, according to an example embodiment of the present invention, it is provided that the machine is part of an actuator assembly, and that the motor constant is ascertained as a function of at least one Coulomb friction coefficient and/or a viscous friction coefficient of the actuator assembly. Taking into account the corresponding friction coefficients creates a particularly advantageously simple function by means of which the motor constant can be ascertained. In particular, an equation system or a matrix is formed, which comprises corresponding friction coefficients and the motor constant to be ascertained as unknowns. By means of the aforementioned Fourier transform, the motor constant can then be ascertained particularly efficiently.

According to a preferred development of the present invention, it is provided that the machine is part of an actuator assembly, and that the motor constant is ascertained as a function of a preload and/or a restoring moment of a spring element of the actuator assembly. Taking into account a preload and/or a restoring moment creates a particularly simple way to ascertain the motor constant. In particular, according to a simplified model for the above-described specific application in the drum brake, an existing mathematical relationship is established between the restoring moment of a return spring and the aforementioned variables and is solved for the motor constant. As an additionally known input variable, the preload and/or the restoring moment of the return spring is accordingly required for this purpose. If the corresponding variable is known, the accuracy of ascertaining the motor constant is advantageously further improved.

Particularly preferably, according to an example embodiment of the present invention, it is provided that the machine is part of an actuator assembly of a friction brake of a motor vehicle, and that the machine is controlled by means of the excitation signal only in the range of an air gap of the friction brake. Controlling only in the range of the air gap results in the advantage that the underlying model can be kept particularly simple since controlling is carried out only in an at least approximately load-free range, and that, in particular, no friction pairing and corresponding forces between the corresponding friction partners of the friction brake must be taken into account.

In a method according to an example embodiment of the present invention for ascertaining a fault state and/or wear state of a friction brake of a motor vehicle that has at least two friction partners, for displacing one of the friction partners to the other friction partner, the friction brake is assigned an actuator assembly with an electric machine, and in that the fault state and/or wear state is ascertained as a function of a motor constant of the machine that is ascertained by the above-described method according to the invention. In particular, the fault state and/or wear state is ascertained by comparing the motor constant and/or a friction coefficient, ascertained as a function of the motor constant, with a specified threshold value and/or tolerance band. The friction brake is in particular designed as an electromechanical drum brake or disk brake. The corresponding method represents a particularly advantageous possible application of the ascertained motor constant. In particular, it advantageously implements simple damage detection; for example, the ascertained motor constant (torque/current) falling below a predetermined limit can be an indicator that the machine is damaged.

In a method according to an example embodiment of the present invention for ascertaining a contact point of two friction partners of a friction brake of a motor vehicle, for displacing one of the friction partners to the other friction partner, the friction brake is assigned an actuator assembly with an electric machine, and in that the contact point of the friction partners is ascertained, in particular by means of a load torque estimator, as a function of a motor constant of the machine that is ascertained by the above-described method according to the invention. A contact point, which is also referred to as a touch point, is understood to mean the point, after overcoming an air gap, from which the friction partners contact each other. The friction brake is in particular designed as an electromechanical drum brake or disk brake. The corresponding method represents a particularly advantageous possible application of the ascertained motor constant. In this specific application, the ascertained system parameters are used to ensure advantageously accurate touch point detection, in which a motor position is in particular ascertained, at which a brake pad comes into contact with a brake disk/brake drum.

A control unit according to an example embodiment of the present invention is specifically configured to perform one of the methods according to the present invention. This results in the aforementioned advantages. In particular, the control unit is designed as a computer device which is assigned to a friction brake of a motor vehicle and is preferably arranged in a motor vehicle.

A friction brake according to an example embodiment of the present invention, comprises at least two friction partners, wherein the friction brake is assigned an actuator assembly with an electric machine, for displacing one of the friction partners to the other friction partner, and includes the control unit according to the present invention. This, too, results in the aforementioned advantages. The friction brake is in particular designed as an electromechanical drum brake or disk brake, as described above.

Further preferred features and combinations of features result from what was described above in the rest of the disclosure herein. The present invention is explained in more detail below with reference to the figures.

### BRIEF DESCRIPTION OF THE DRAWINGS

FIG. 1 shows an electromechanical drum brake, according ot an example embodiment of the present invention.

FIG. 2 shows a rotation rate vs. motor current diagram of the drum brake, according to the present invention.

FIG. 3 shows methods for ascertaining parameters of the drum brake, according to an example embodiment of the present invention.

### DETAILED DESCRIPTION OF EXAMPLE EMBODIMENTS

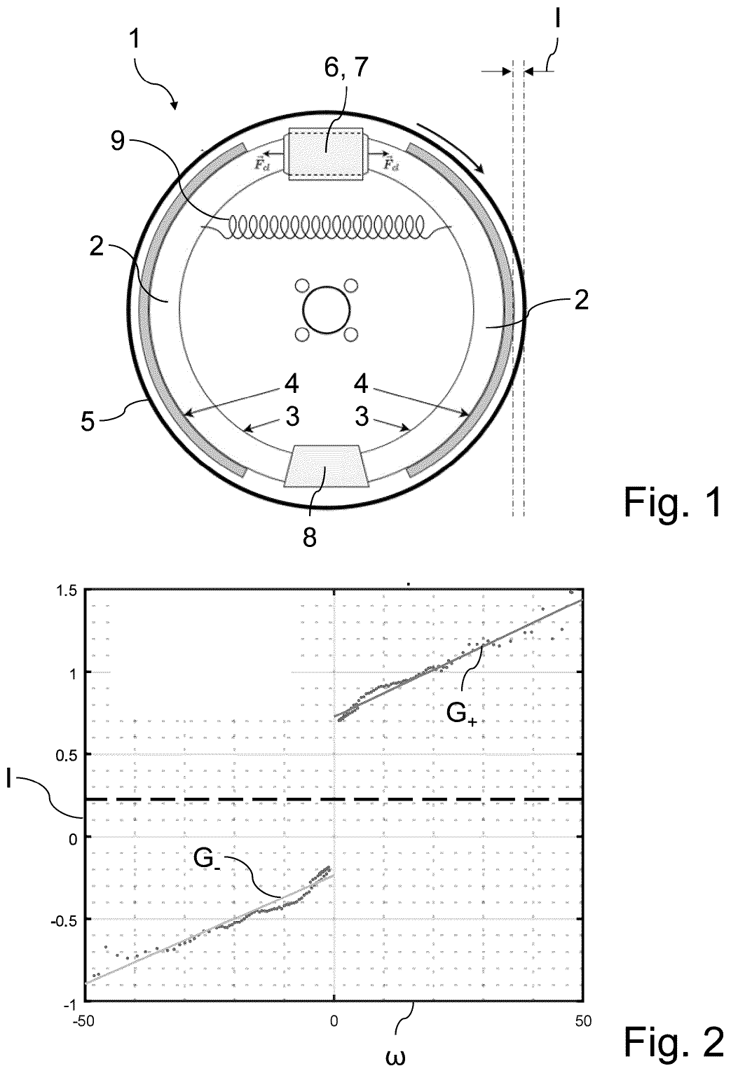

FIG. 1 shows a simplified form of an exemplary design of an electromechanical friction brake 1 of an otherwise not further illustrated motor vehicle. In the present case, the friction brake 1 is designed as a simplex drum brake and comprises two first friction partners 2 in the form of brake shoes 3 with brake pads 4 arranged thereon, and a second friction partner 5 in the form of a brake drum 5. The first friction partners 2 are each assigned to the second friction partner 5.

For displacing each first friction partner 2 to the second friction partner 5, the friction brake 1 is assigned an actuator assembly 6 with an electric machine 7. The electric machine 7 is operatively connected to a first end of the first friction partners 2, for example by means of a gear assembly not shown, in order to apply a corresponding actuating force F to them. The friction partners 2 are mounted on an abutment 8 so as to be rotatable about a second end facing away from the first end.

In order that a braking torque is actually generated, the friction partners 2 must first overcome an air gap 1 until the corresponding brake pad 4 makes contact with the brake drum 5. In order to ensure that the brake pads 4 in the unactuated state do not rub against the brake drum 5, a spring element 9 is provided as a return spring with a certain preload, which spring element is attached at each end to one of the two brake shoes 3 and pushes the two brake shoes 3 toward each other.

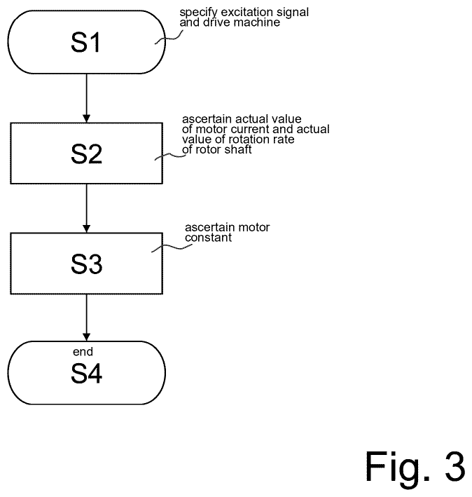

With reference to FIG. 3, an advantageous method for ascertaining various parameters of the actuator assembly 6 described, in particular a motor constant of the electric machine 7, is described below. For this purpose, FIG. 3 shows the method in the form of a flow chart. In particular, the method ensures that the parameters, which may change over the service life due to, for example, component spreading and wear, are always determined with high accuracy. In particular, at least one of the methods described below is performed by means of a control unit specifically configured for this purpose.

The method is based on a simplified state space model of the actuator assembly 6. The actuator assembly 6 can thus be described sufficiently accurately as a second-order dynamic system. Non-linearities are predominantly the load, which results from the stiffness characteristic curve of the friction brake 1, as well as friction effects within the actuator assembly 6. Assuming that the method is performed exclusively in the range of the air gap 1, the load can be neglected.

The air gap is characterized by two motor positions θ_{L,min} and θ_{L,max}, which limit the allowable motor position range in the air gap [symbol] ⊇{θ|θ_{L,min}<θ<θ_{L,max}}. They may be specified for design reasons or ascertained using a conservative method.

For the friction that works against the motor torque, a common approximation in practice and literature is then carried out.

The friction model is described with three parameters in the form of friction coefficients, a viscous friction factor D, and two Coloumb factors C₊ and C₋, each of which applies to the actuation and opening of the friction brake 1.

Since the electrical time constant is typically much smaller than the mechanical time constant, precise modeling of the electric machine 6 can be dispensed with, and the relationship between actuation current Iₘ and torque τₘ≈IₘKₘ via the motor constant Kₘ can be used instead.

The differential equation, which approximately describes the system behavior (change in the rotational motor position θ), is therefore

$$\ddot{θ} \approx {J}^{- 1} ( {τ}_{m} - \dot{θ} D - sign ( \dot{θ} ) {C}_{s} )$$

Here, J is the rotational total inertial mass of the actuator mechanism (usually known) and the following applies:

$${C}_{s} = \{ \begin{matrix}{C}_{+} if \dot{θ} > ϵ \\ {C}_{-} if \dot{θ} < - ϵ\end{matrix}$$

The positive scalar ϵ is understood to mean a Karnopp factor and describes a zero speed band. It is assumed that a corresponding rotor position sensor of the electric machine 6 is sufficiently accurate to calculate the rotational speed ω [symbol] \dot{θ} with acceptable error, for example by means of a finite difference method.

In a step S1, the method begins with specifying at least one excitation signal having at least one direct current component and one alternating current component, and with driving the machine 7 by means of the excitation signal, in particular only in the range of the air gap 1 of the friction brake 1. The alternating current component preferably has at least one harmonic frequency, in particular a plurality of different harmonic frequencies.

The excitation signal is thus in particular composed of a direct current component I₀ and one or more harmonic alternating current components Iₖ(t)=αₖsin(ωₖt+ϕₖ):

$${I}_{m} ( t ) = {I}_{0} + {\sum }_{k = 1}^{K} {I}_{k} ( t )$$

The use of multiple harmonics (K>1) is advantageous in order to obtain a higher robustness in the identification of the motor constant, which becomes apparent in the following sections.

In a step S2, at least one actual value of a motor current of the machine 7 and one actual value of a rotation rate of a rotor shaft of the machine 7 are ascertained in each case. Preferably, actual temporal profiles of the motor current and of the rotation rate that result from the excitation signal (Iₘ) are ascertained for this purpose in each case, and that average values are ascertained as respective actual values as a function of the actual profiles. In particular, the actual profiles are ascertained over at least two periods of the alternating current component (Iₖ). Particularly preferably, an average value of the motor constant is ascertained by means of a plurality of different excitation signals.

Depending on the direct current component selected, a measurable average rotation rate arises after the transient response (t>Tₑ) of the rotation rate ω(t):

$$\overline{ω} = \frac{1}{T - {T}_{e}} {\int }_{{T}_{e}}^{T} ω dt$$

Here, it should only be noted that |ω|>ϵ∀t>Tₑ so that no stick-slip effects occur, which are not taken into account in the simplified model. For a series of measurements with different I₀, the Coloumb factor as well as the viscous friction as a function of the still unknown motor constant Kₘ can very simply be determined via linear interpolation.

FIG. 2 shows a corresponding rotation rate vs. motor current diagram with a plurality of measurement points for motor current I and rotation rate ω. As already described above, the state space model used has different friction coefficients as further unknowns. It is therefore advantageous if the motor constant Kₘ is ascertained as a function of the Coulomb friction coefficients C₊, C₋ and the viscous friction coefficient D of the actuator assembly 6.

The corresponding ascertainment of the friction coefficients is preferably carried out via a linear fit to the data points. The slope of a corresponding straight line G₊ (for the friction coefficient (C₊) or G₋ (for the friction coefficient C₊) in each case corresponds to

$$\frac{1}{{K}_{m}} D .$$

The y-intercept corresponds to

$$\frac{1}{{K}_{m}} {C}_{s} .$$

In this example, the Coloumb friction is different for positive and negative rotation rates (the dashed line shown corresponds to

$$y = \frac{1}{2 {K}_{m}} ( {C}_{+} + {C}_{-} ) \neq 0 ) .$$

The resulting relationship is:

$${K}_{m} {I}_{o} = {C}_{s} + D \overline{ω} ⇒ {I}_{0} = \frac{1}{{K}_{m}} {C}_{s} + \frac{1}{{K}_{m}} D \overline{ω}$$

With N≥2 independent measurements, the equation system can be solved:

$$[ \begin{matrix}{I}_{0}^{( 1 )} & {I}_{0}^{( 2 )} & … & {I}_{0}^{( N )}\end{matrix} ] = [ \begin{matrix}\frac{1}{{K}_{m}} {C}_{S} & \frac{1}{{K}_{m}} D\end{matrix} ] \cdot [ \begin{matrix}1 & 1 & … & 1 \\ {\overline{ω}}^{( 1 )} & {\overline{ω}}^{( 2 )} & … & {\overline{ω}}^{( N )}\end{matrix} ] ⇒ A := [ \begin{matrix}{A}_{1} & {A}_{2}\end{matrix} ] = [ \begin{matrix}\frac{1}{{K}_{m}} {C}_{S} & \frac{1}{{K}_{m}} D\end{matrix} ] = [ \begin{matrix}{I}_{0}^{( 1 )} & {I}_{0}^{( 2 )} & … & {I}_{0}^{( N )}\end{matrix} ] \cdot {[ \begin{matrix}1 & 1 & … & 1 \\ {\overline{ω}}^{( 1 )} & {\overline{ω}}^{( 2 )} & … & {\overline{ω}}^{( N )}\end{matrix} ]}^{†}$$

In a step S3, the motor constant is ascertained as a function of the excitation signal and the actual values. One option is to solve the equation system by means of a Fourier transform.

Due to the assumption of a linear model and due to the superposition principle, the system as well as the excitation signal are in particular divided into multiple subsystems:

$$\dot{ω} := \ddot{θ} = {\ddot{θ}}_{0} + {\ddot{θ}}_{1} + … + {\ddot{θ}}_{K}$$

$${\dot{ω}}_{0}^{′} := {\ddot{θ}}_{0} = {J}^{- 1} ( {I}_{0} {K}_{m} - {C}_{s} - {\dot{θ}}_{0} D )$$

$${\dot{ω}}_{1}^{′} := {\ddot{θ}}_{1} = {J}^{- 1} ( {a}_{1} sin ( {ω}_{1} t ) {K}_{m} - {\dot{θ}}_{1} D )$$

$$…$$

$${\dot{ω}}_{K}^{′} := {\ddot{θ}}_{K} = {J}^{- 1} ( {a}_{K} sin ( {ω}_{K} t ) {K}_{m} - {\dot{θ}}_{K} D )$$

The transfer function in the Laplace domain of the subsystems ω′₁ω′₂, . . . , ω′_{K} is

$${H}_{k} ( s ) := \frac{{Ω}_{k}^{′} ( s )}{{I}_{k} ( s )} = \frac{{K}_{m}}{J ( s + {DJ}^{- 1} )}$$

from which the following equation system can be derived:

$${K}_{m}^{2} - {\vert {H}_{k} ( j {ω}_{k} ) \vert}^{2} {D}^{2} - {\vert {H}_{k} ( j {ω}_{k} ) \vert}^{2} {J}^{2} {ω}_{k}^{2} = 0 ⇒ {K}_{m}^{2} - {\vert {H}_{k} ( j {ω}_{k} ) \vert}^{2} {( {K}_{m} {A}_{2} )}^{2} - {\vert {H}_{k} ( j {ω}_{k} ) \vert}^{2} {J}^{2} {ω}_{k}^{2} = 0 ⇒ {K}_{m} ( {ω}_{k} ) := \frac{\vert {H}_{k} ( j {ω}_{k} ) \vert J {ω}_{k}}{√ ( 1 - {\vert {H}_{k} ( j {ω}_{k} ) \vert}^{2} {A}_{2}^{2} )}$$

The absolute values of the Fourier coefficients of the rotation rate signal ω(t) at the frequencies ω₁ω₂, . . . , ω_{K} can be used to ascertain the values for |Hₖ(jωₖ)| simply and to determine all uncertain parameters D, C₊, C₋ and Kₘ using the previously calculated A. The ascertained values become more robust if multiple excitation frequencies are used (K>1), the parameters for the individual frequencies can then be averaged, for example:

$${\overline{K}}_{m} = \frac{1}{K} {\sum }_{k = 1}^{K} {K}_{m} ( {ω}_{k} )$$

In first experiments, frequencies between 10 and 20 Hz and an amplitude αₖ of about 1 A have proven to be advantageous.

A second, alternative option is that the motor constant Kₘ is ascertained as a function of a preload and/or a restoring moment of the spring element 9 of the actuator assembly 6.

As can be seen in FIG. 2, the Coloumb friction in electromechanical drum brakes with return spring may be dependent on the sign of the rotation rate (different friction when actuating than when opening). The difference results from the preload of the return spring and from the friction in the suspension of the brake shoes.

If the preload and the resulting restoring moment τ_{F} of the return spring are known and the friction in the brake shoe suspension is negligible, the motor constant Kₘ can be ascertained after A has been determined (see previous sections):

$${τ}_{F} = \frac{1}{2 {K}_{m}} ( {C}_{+} + {C}_{-} ) ⇒ {K}_{m} = \frac{1}{2 {τ}_{F}} ( {C}_{+} + {C}_{-} )$$

The method ends with a step S4. Optionally, the motor constant just ascertained and/or at least one of the friction coefficients may now be used to ascertain further parameters or to serve as an input variable for methods based thereon.

On the one hand, this may be a method for ascertaining a fault state and/or wear state of the friction brake. Here, the fault state and/or wear state is ascertained as a function of the ascertained motor constant Kₘ of the machine 7, in particular by comparing the motor constant Kₘ and/or at least one of the friction coefficient D, C₊, C₋, ascertained as a function of the motor constant Kₘ as described above, with a specified threshold value and/or tolerance band.

For example, damage or the like can be detected if the ascertained system parameters are outside a tolerance band, i.e., for example, the motor constant is below a specified threshold value and/or the viscous friction coefficient exceeds a specified threshold value:

$${K}_{m} < {K}_{m , min} , D > {D}_{max} , …$$

On the other hand, this may be a method for ascertaining a contact point of the friction partners 2, 5 of the friction brake 1. Here, the contact point of the friction partners is also ascertained, in particular by means of a load torque estimator, as a function of the ascertained motor constant Kₘ of the machine 7.

A load torque estimator is thus implemented in particular based on the simplified linear actuator model described above. Here, the model is extended by a virtual state variable \hat{τ}_{L}, for example as follows:

$$\ddot{θ} = {J}^{- 1} ( {τ}_{m} - \dot{θ} D - sign ( \dot{θ} ) {C}_{s} + {\hat{τ}}_{L} ) + 𝓌$$

$${\dot{\hat{τ}}}_{L} = 𝓋$$

The terms [symbol] and [symbol] are assumed, zero-mean system noise as is common with model-based estimators. With this formulation, a Kalman filter can be implemented, for example. A threshold value, for example \hat{τ}_{L}>τₜₕᵣₑₛₕ, may be used as a criterion for touch point detection. The accuracy of the estimator and of the detection benefits from the ascertained system parameters.

What is claimed is:

1. A method for ascertaining a motor constant of an electric machine, the method comprising the following steps:
specifying at least one excitation signal having at least one direct current component and one alternating current component;
controlling the machine using the excitation signal;
ascertaining at least one actual value of a motor current of the machine and one actual value of a rotation rate of a rotor shaft of the machine; and
ascertaining the motor constant as a function of the excitation signal and the actual value of the motor current and the actual value of the rotation rate.

2. The method according to claim 1, wherein actual temporal profiles of the motor current and of the rotation rate that result from the excitation signal are ascertained in each case, and average values are ascertained as respective actual values as a function of the actual temporal profiles of the motor current and of the rotation rate.

3. The method according to claim 2, wherein the actual profiles of the motor current and of the rotation rate are ascertained over at least two periods of the alternating current component.

4. The method according to claim 1, wherein the alternating current component has a plurality of different harmonic frequencies.

5. The method according to claim 1, wherein an average value of the motor constant is ascertained using a plurality of different excitation signals.

6. The method according to claim 1, wherein the motor constant is ascertained using a Fourier transform.

7. The method according to claim 1, wherein the machine is part of an actuator assembly, and the motor constant is ascertained as a function of at least one Coulomb friction coefficient and/or a viscous friction coefficient of the actuator assembly.

8. The method according to claim 1, wherein the machine is part of an actuator assembly, and the motor constant is ascertained as a function of a preload and/or a restoring moment of a spring element of the actuator assembly.

9. The method according to claim 1, wherein the machine is part of an actuator assembly of a friction brake of a motor vehicle, and the machine is controlled using the excitation signal only in a range of an air gap of the friction brake.

10. A method for ascertaining a fault state and/or wear state of a friction brake including at least two friction partners, of a motor vehicle, wherein the friction brake is assigned an actuator assembly with an electric machine, for displacing one of the friction partners to the other of the friction partners, the method comprising:
specifying at least one excitation signal having at least one direct current component and one alternating current component;
controlling the machine using the excitation signal;
ascertaining at least one actual value of a motor current of the machine and one actual value of a rotation rate of a rotor shaft of the machine;
ascertaining a motor constant as a function of the excitation signal and the actual value of the motor current and the actual value of the rotation rate; and
ascertaining the fault state and/or wear state is ascertained as a function of the ascertained motor constant of the machine by comparing: (i) the ascertained motor constant and/or a friction coefficient ascertained as a function of the motor constant, with (ii) a specified threshold value and/or tolerance band.

11. A method for ascertaining a contact point of two friction partners of a friction brake of a motor vehicle, wherein the friction brake is assigned an actuator assembly with an electric machine, for displacing one of the friction partners (2) to the other of the friction partners, the method comprising:
specifying at least one excitation signal having at least one direct current component and one alternating current component;
controlling the machine using the excitation signal;
ascertaining at least one actual value of a motor current of the machine and one actual value of a rotation rate of a rotor shaft of the machine;
ascertaining a motor constant as a function of the excitation signal and the actual value of the motor current and the actual value of the rotation rate; and
ascertaining the contact point of the friction partners is ascertained, using a load torque estimator, as a function of the ascertained motor constant.

12. A control unit specifically configured to ascertain a motor constant of an electric machine, the control unit configured to:
specify at least one excitation signal having at least one direct current component and one alternating current component;
control the machine using the excitation signal;
ascertain at least one actual value of a motor current of the machine and one actual value of a rotation rate of a rotor shaft of the machine; and
ascertain the motor constant as a function of the excitation signal and the actual value of the motor current and the actual value of the rotation rate.

13. A friction brake of a motor vehicle, with at least two friction partners, wherein the friction brake is assigned an actuator assembly with an electric machine, for displacing one of the friction partners to the other of the friction partners, the friction brake comprising:
a control unit specifically configured to ascertain a motor constant of the electric machine, the control unit configured to:
specify at least one excitation signal having at least one direct current component and one alternating current component,
control the machine using the excitation signal, ascertain at least one actual value of a motor current of the machine and one actual value of a rotation rate of a rotor shaft of the machine, and
ascertain a motor constant as a function of the excitation signal and the actual value of the motor current and the actual value of the rotation rate.
